(19) United States
(12) Patent Application Publication
(10) Pub. No.: US 2006/0152805 A1
(43) Pub. Date: Jul. 13, 2006

(54) Light guide and line illuminator

(76) Inventors: Makoto Ikeda, Osaka (JP); Hiroyuki Nemoto, Osaka (JP)

Correspondence Address: CARRIER BLACKMAN AND ASSOCIATES, 24101 NOVI ROAD, SUITE 100, NOVI, MI, 48375, US

(21) Appl. No.: 10/562,335

(22) PCT Filed: Jun. 18, 2004
(86) PCT No.: PCT/JP04/08623

§ 371 Date: Dec. 23, 2005

(30) Foreign Application Priority Data
Jun. 25, 2003 (JP) 2003-181631

(51) Int. Cl. G02B 5/12

(52) U.S. Cl. 359/515

(57) ABSTRACT

A light guide capable of reducing the degrading of the read image, even when the document face is raised, by expanding the distribution of light intensities in the longitudinal direction in the position of the irradiated item (document position), and a line illuminator into which the light guide is incorporated. The light guide emits lights incident on an end face from an emitting face extending longitudinally, while having the lights reflected by an internal face of the guide. The sectional shape of the internal face in a direction orthogonal to the longitudinal direction is provided with first and second oval arc curved faces, first and second emitting faces, and a light scattering part formed on the focal position (or a position near the focus) of the oval on the longer axis plane of each oval. The concentrating position of lights reflected by the first curved face and the concentrating position of lights reflected by the second curved face are different from each other.

### TECHNICAL FIELD

The present invention relates to a light guide for illuminating documents in a line shape in facsimile machines, copying machines, scanners and the like, and an image reader having this light guide incorporated therein.

### BACKGROUND ART

There is proposed, for the purpose of effectively irradiating the object of irradiation with lights from light sources, what uses a light guide whose side faces are paraboloids or oval arcs (see Patent Document 1 and Patent Document 2 for instance).
Patent Document 1: Japanese Patent Laid-Open No. 2001-b 30734
Patent Document 2: U.S. Pat. No. 6,259,082

### DISCLOSURE OF THE INVENTION

Problems to be Solved by the Invention

There is a problem that the focus of lights emitted from a light guide is shallow in depth, resulting in low brightness of an object far from the focus. For this reason, the luminous energy of illumination may drop when a document placed on a document mount or the like is raised by a fold or a spread of the document, and an unnatural shadow may appear on the image read by a line image sensor or the like.

An object of the present invention, attempted to solve this problem, is to provide a light guide capable of reducing the degrading of the read image, even when the document face is raised, by expanding the distribution of light intensities in the longitudinal direction in the position of the irradiated item (document position), and a line illuminator having that light guide incorporated therein.

Means for Solving the Problems

In order to solve the problem noted above, the light guide pertaining to the invention has such a configuration that it emits lights incident from an end face from an emitting face disposed along the longitudinal direction while having the lights reflected by two internal side faces thereof, the sectional shapes of side faces in a direction orthogonal to the longitudinal direction (the shapes of the two side faces along the longitudinal direction) have two oval arc curves or two paraboloid curves, and the concentrating position of lights reflected by one side face and the concentrating position of lights reflected by the other side face are different from each other.

In the foregoing case, the light guide is configured by sticking together two half pieces, and oval arcs or paraboloids, which constitute reflective faces, are formed on the half pieces. The light guide may be unitarily formed instead of sticking together two half pieces.

Also, the light guide pertaining to the invention which emits lights incident from an end face from an emitting face disposed along the longitudinal direction while having the lights reflected by two internal side faces thereof, may have such a configuration that the sectional shapes of both of the two internal side faces are oval arc curves, and the difference in focal distance between the oval arc curves makes the concentrating positions of reflected lights different.

Further, the light guide pertaining to the invention which emits lights incident from an end face from an emitting face disposed along the longitudinal direction while having the lights reflected by the internal side faces thereof, may have such a configuration that the sectional shape in the in a direction orthogonal to the longitudinal direction has at least one curved face, and that curved face has two oval arc curved areas differing in focal distance from each other.

The image reader pertaining to the invention may have two pairs, for instance, of illuminating units each provided with a light source on one end or both ends of the light guide, and the illuminating units are so arranged as to cause lights emitted from the emitting faces to irradiate the same area of the face to be read of the document.

### ADVANTAGES OF THE INVENTION

The light guide according to the invention and the using that light guide make it possible to give desirable light distribution characteristics to the prescribed position and depth by combining light guides differing in focal position. Thus it is made possible to reduce the degrading of the read image and read in a satisfactory image, even when the document face is raised, by expanding the distribution of light intensities in the longitudinal direction in the position of the irradiated item (document position).

### BRIEF DESCRIPTION OF THE DRAWINGS

FIG. 1 is a diagram showing the sectional shape of a light guide in a first mode for carrying out the present invention;

FIG. 2 is a sectional view of a contact image sensor (CIS) provided with a line illuminator in which the light guide according to the invention is incorporated;

FIG. 3 is a diagram showing the fitting positions of light emitting diodes as light sources disposed on an end face of the light guide according to the invention;

FIG. 4 is a diagram showing the sectional shape of another light guide according to the invention;

FIG. 5 is a diagram showing the sectional shape of another light guide according to the invention;

FIG. 6 is a diagram showing the sectional shape of still another light guide according to the invention; and

FIG. 7 is a diagram showing the sectional shape of yet another light guide according to the invention.

### BEST MODES FOR CARRYING OUT THE INVENTION

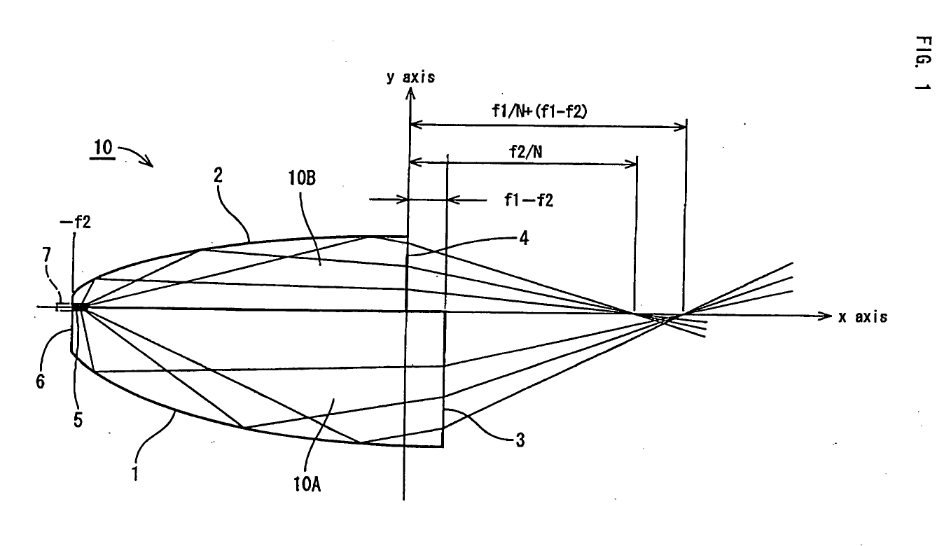

The best modes for carrying out the present invention will be described below with reference to the accompanying drawings. FIG. 1 is a diagram showing the sectional shape of a light guide in a first mode for carrying out the invention.

A light guide 10 is configured by sticking together half pieces 10A and 10B formed of a transparent resin, such as acryl for instance, and its sectional shape is constant over the full length (e.g. 320 mm) of the light guide 10.

A first curved face 1 formed on the half piece 10A is the shape of an area represented by:
[{x−(f1−f2)}/10.6]²+(y/3.5)²≦1
and −f2≦x≦f1−f2, y≦0.

A second curved face 2 formed on the half piece 10B is the shape of an area represented by:
(x/9.2)+(y/2.0)≦1
and −f2≦x≦0, y≧0. Provided that f1=10.0=(10.6²−3.5²)^{0.5}
f2=900=(9.2²−2.0²)^{0.5}

x=−f1, y=0 is the coordinate of the focus of the curve 1.

x=−f2, y=0 is the coordinate of the focus of the curve 2.

Here, a light scattering part 5 consisting of a white ink printing pattern is disposed in the area of x=−f2+Δ, y=0. Reference numeral 6 denotes the bottom face.

When there is any propagating light within the light guide 10, the propagating light having reached the light scattering part 5 consisting of a printing pattern is scattered, totally reflected by the curved faces 1 and 2, and emitted from respective emitting faces 3 and 4.

The emitted light reflected by the curved face 1 concentrates in the vicinities of the coordinate x=7.7(=f1/N+(f1−f2)), y=0; provided that N is a rod refractive index, N=1.49 when the light guide 10 is made of acryl.

The emitted light reflected by the curved face 2 concentrates in the vicinities of the coordinate x=6.0(=f2/N), y=0; provided that N is a rod refractive index, N=1.49 when the light guide 10 is made of acryl.

Since the emitting face is positioned in a direction in which there is almost no scattering directionality when the light scattering part 5 is formed on the longer axis plane, the scattered lights are emitted after being reflected by the oval faces. By forming the light scattering part 5 on the longer axis plane of the oval in this way, lights directly irradiating the emitting face are restrained, resulting in enhancement of the efficiency of light concentration by the oval reflective face. In the diagram, the virtual line denotes a mirror image 7 of the light scattering part 5. By chamfering the tip of the oval on the longer axis side along a perpendicular plane containing the focus of the oval or its vicinities (the plane orthogonal to the longer axis), the mirror image of the light scattering part 5 can also be positioned near the focus on the longer axis plane, similarly subject to little loss (contributing to mirror image reflection).

Incidentally, though the light guide 10 shown here consists of a light guide shaped substantially as a quarter of an oval having an ovally curved face 1 and the half pieces 10A and 10B, each shaped substantially as a quarter of an oval, having an ovally curved face 2 being stuck together, it may be unitarily formed. Further, though the curved faces are oval arcs here, they may as well be paraboloidal.

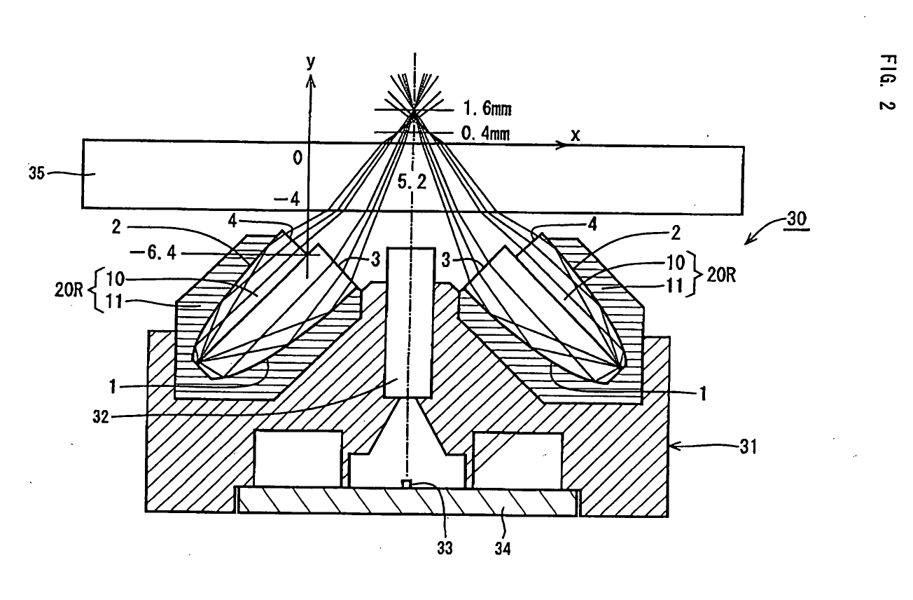

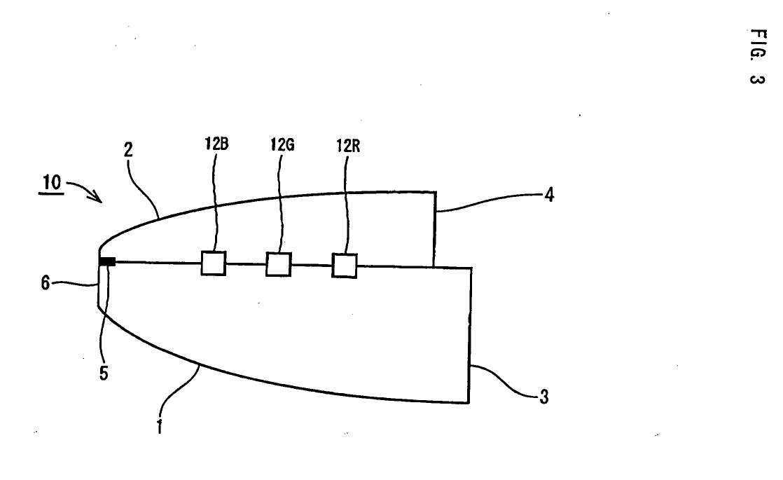

FIG. 2 is a sectional view of a contact image sensor (CIS) provided with a line illuminator in which the light guide according to the invention is incorporated, and FIG. 3, a diagram showing the fitting positions of light emitting diodes as light sources disposed on an end face of the light guide according to the invention.

The contact image sensor (CIS) 30 shown in FIG. 2 is provided with a box 31; two pairs of line illuminators 20L and 20R are built into this box 31; a lens array 32 of an erecting unit magnification system is arranged in the box 31; and further a substrate 34 provided with a line image sensor 33 is fitted into the lower part of the box 31. Reference numeral 35 denotes a cover glass constituting a document mount.

It is desirable to use lenses of great focal depths as the lens array 32 of an erecting unit magnification system. The use of a lens array of great focal depths makes possible reading of a clear image even when the document face is raised. Further, since no image can eventually be read if the illuminating light fails to reach the object however great the focal depths may be, it is desirable for both the illuminating system and the erecting unit magnification system to satisfy respectively prescribed requirements, namely great focal depths for the erecting unit magnification system and uniform illumination of that range of focal depths for the illuminating system.

Each of the line illuminators 20L and 20R comprises the light guide 10 shown in FIG. 1, a light guide case 11, and a light source board (not shown) provided with light emitting diodes 12R, 12G and 12B shown in FIG. 3. The light emitting diodes 12R, 12G and 12B respectively emit red, green and blue lights, and these light emitting diodes 12R, 12G and 12B are chip type diodes (LED chips).

In this mode for implementing the invention, as shown in FIG. 3, the light emitting diodes 12R, 12G and 12B are arranged in a row along the x axis shown in FIG. 1.

Lights from the light emitting diodes 12R, 12G and 12B propagate within the light guide 10, and cause scattered lights to be generated on the bottom face 1. As shown in FIG. 2, these scattered lights are reflected by the curved faces 1 and 2. Lights reflected by the curved face 1 concentrate on a position 0.4 mm above the upper face of a cover glass 35, while lights reflected by the curved face 2 concentrate on a position 1.7 mm ahead of it (a position 1.6 mm above the upper face of the cover glass 35).

And the illuminating lights 7 reflected by the face to be read of the document, not shown, are detected by the line image sensor 33 via the cover glass 35 and the lens array 32. This causes the document to be read.

In the contact image sensor (CIS) 30 equipped with the line illuminators 20L and 20R into each of which a light guide according to the invention is incorporated, variations of luminous energy were kept within 5% at y=0 to 2 mm (the range of up to 2 mm above the upper face of the cover glass 35) in the position of x=5.2 mm (the central position of the lens array 32 and the line image sensor 33) as shown in FIG. 2).

Therefore, even when the document face is raised, variations of luminous energy on the face of the document are slight, enabling a satisfactory read image to be obtained.

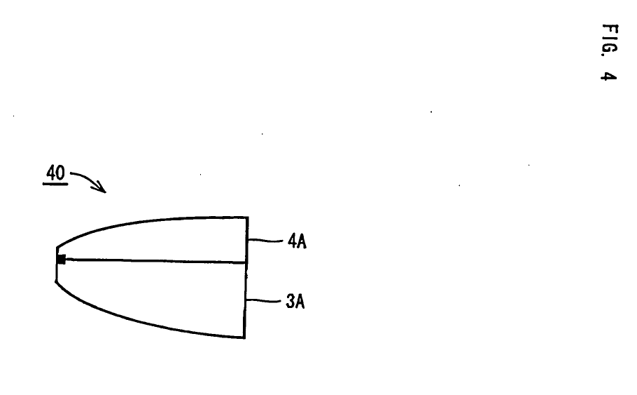

FIG. 4 is a diagram showing the sectional shape of another light guide according to the invention. A light guide 40 shown FIG. 4 is cleared of level gaps of emitting faces 3A and 4A.

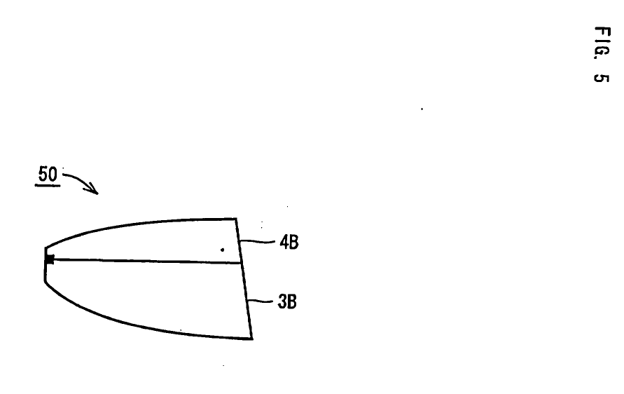

FIG. 5 is a diagram showing the sectional shape of another light guide according to the invention. A light guide 50 shown in FIG. 5 has inclined emitting faces 3B and 4B to give them prismatic deflective effects.

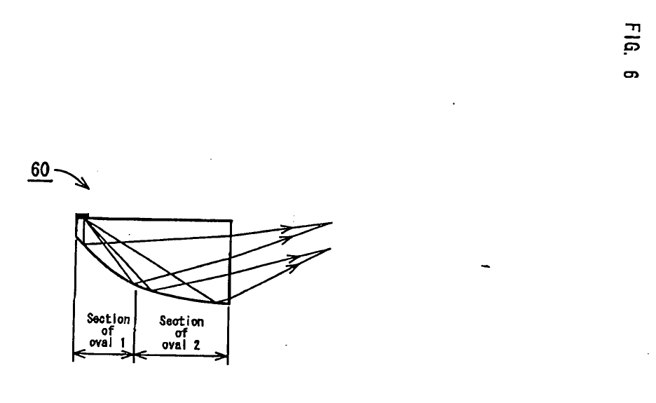

FIG. 6 is a diagram showing the sectional shape of still another light guide according to the invention. A light guide 60 shown in FIG. 6 has one curved face formed by combining first and second oval sections differing in curvature.

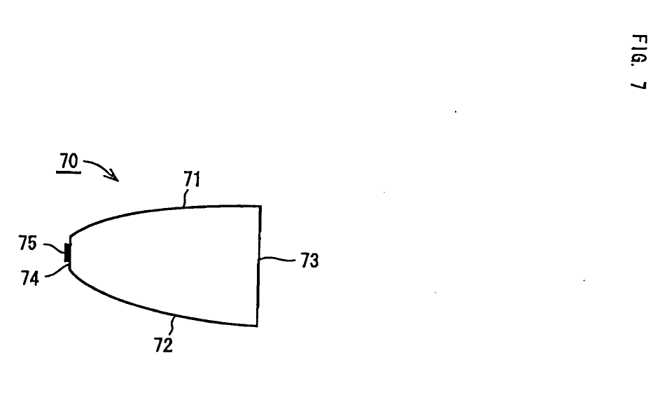

FIG. 7 is a diagram showing the sectional shape of yet another light guide according to the invention. A light guide 70 shown in FIG. 7 is a unitarily formed light guide, of which a first curved face 71 is the shape of an area represented by:
[{x−(f1−f2)}/10.6]²+(y/3.5)²≦1
and −f2≦x≦f1−f2, y≦0, while a second curved face 72 is the shape of an area represented by: (x/9.2)²+(y/2.0)²≦1, and −f2 ≦x≦0, y≦0. A bottom face 74 opposite to an emitting face 73 is provided with a light scattering part 75 consisting of a white ink printing pattern.

1. A light guide having an end face, an emitting face and two internal side faces, and which emits lights incident on the end face from the emitting face extending longitudinally of the guide, while the lights are reflected by the internal side faces, wherein sectional shapes of said two internal side faces are oval arc curves or paraboloid curves, and a concentrating position of lights reflected by one side face and a concentrating position of lights reflected by the other side face are different from each other.

2. The light guide according to claim 1, wherein said light guide is integrally formed as a unitary member.

3. The light guide according to claim 1, wherein said light guide includes two half pieces connected together, and oval arcs or paraboloids, which constitute reflective faces, are formed on the half pieces.

4. The light guide according to claim 3, wherein a light scattering part is formed in connecting faces of said half pieces together.

5. A light guide having an end face, an emitting face and two internal side faces, and which emits lights incident on the end face from the emitting face extending longitudinally of the guide, while the lights are reflected by the internal side faces, wherein sectional shapes of both of said two internal side faces are oval arc curves, and a difference in focal distance between the oval arc curves causes concentrating positions of reflected lights to be different.

6. A light guide having an end face, an emitting face and internal side faces, and which emits lights incident on the end face from the emitting face extending longitudinally of the guide, while the lights are reflected by the internal side faces, wherein sectional shapes of the internal side surfaces have two oval arc curved areas, and concentrating positions of reflected lights differ from one oval arc curve to the other.

7. An image reader characterized in that an illuminating unit comprising the light guide according to claim 1, a light source provided at an end face of the light guide, and a lens array for converging on a light receiving element lights radiated from the illuminating unit toward a document and reflected by the document or transmitted by the document, and a box housing the illuminating unit, the lens array and the light receiving element.

8. The image reader according to claim 7 including two of said illuminating units, and the illuminating units are so arranged as to cause lights emitted from the emitting faces of the light guides thereof to irradiate the same area of an illuminated face of the document.

9. An image reader characterized in that an illuminating unit comprising the light guide according to claim 5, a light source provided at an end face of the light guide, and a lens array for converging on a light receiving element lights radiated from the illuminating unit toward a document and reflected by the document or transmitted by the document, and a box housing the illuminating unit, the lens array and the light receiving element.

10. The image reader according to claim 9 including two of said illuminating units, and the illuminating units are so arranged as to cause lights emitted from the emitting faces of the light guides thereof to irradiate the same area of an illuminated face of the document.

11. An image reader characterized in that an illuminating unit comprising the light guide according to claim 6, a light source provided at an end face of the light guide, and a lens array for converging on a light receiving element lights radiated from the illuminating unit toward a document and reflected by the document or transmitted by the document, and a box housing the illuminating unit, the lens array and the light receiving element.

12. The image reader according to claim 11 including two of said illuminating units, and the illuminating units are so arranged as to cause lights emitted from the emitting faces of the light guides thereof to irradiate the same area of an illuminated face of the document.
